(19) United States
(12) Patent Application Publication
(10) Pub. No.: US 2026/0211713 A1
(43) Pub. Date: Jul. 23, 2026

(54) TESTING MOBILE DEVICE MANAGEMENT USING A VIRTUAL DEVICE

(71) Applicant: INTERNATIONAL BUSINESS MACHINES CORPORATION, ARMONK, NY (US)

(72) Inventors: Manas Pandey, Bengaluru (IN); Kiran Kumar Naidu Srp, Bengaluru (IN)

(21) Appl. No.: 19/032,701

(22) Filed: Jan. 21, 2025

(51) Int. Cl. G06F 9/455

(52) U.S. Cl. CPC G06F 9/45558; G06F 2009/45595

(57) ABSTRACT

A method for testing mobile device management (MDM). The method includes a virtual device module establishing a unique device identifier, and the virtual device module communicating the unique device identifier with a MDM server. The method can also include the MDM server sending an identity certificate to the virtual mobile device module, and the virtual mobile device module storing the identity certificate in a mapping.

### BACKGROUND

The present disclosure relates generally to electronic devices, and more specifically, to mobile device management of mobile devices.

Organizations nowadays incur huge costs in procuring newer versions of physical mobile devices every year. Operational expenses involved with mobile devices can also be large.

### SUMMARY

According to some embodiments of the disclosure, there is provided a method for testing mobile device management (MDM). The method includes a virtual device module establishing a unique device identifier, and the virtual device module communicating the unique device identifier with a MDM server.

According to some embodiments of the disclosure, there is provided a method for validating MDM. The method includes a virtual device module sending at least one request to a MDM server. The method also includes the virtual mobile device module storing at least one response from the MDM server to the at least one request. The method further includes the virtual mobile device module validating the at least one response as per at least one established operating system (OS) response.

According to some embodiments of the disclosure, there is provided a method of enrolling a virtual mobile device using MDM. The method includes a virtual device module generating a virtual mobile device. The method also includes the virtual mobile device module sending a request to a MDM server. The method further includes the MDM server sending an enrollment request to the virtual device. In addition, the method includes the virtual mobile device requesting an identity certificate to the MDM server. In addition, the method includes the identity certificate signing one or more requests sent to the MDM server. Further, the method includes completing enrollment of the virtual mobile device.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram illustrating interaction between a virtual mobile device module and a mobile device management (MDM) server, in accordance with embodiments of the disclosure.

FIG. 2 is a block diagram illustrating another interaction between the virtual mobile device module and the MDM server, in accordance with embodiments of the disclosure.

FIG. 3 is a flow diagram illustrating a validation process, in accordance with embodiments of the present disclosure.

FIG. 4 is a flow diagram illustrating a validation process, in accordance with embodiments of the present disclosure.

FIG. 5 is a block diagram illustrating a virtual device MDM enrollment, in accordance with embodiments of the present disclosure.

FIG. 6 is a block diagram view of a system, in accordance with some embodiments.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Aspects of the present disclosure generally relate to mobile device management (MDM) and mobile devices. More particularly, aspects of the present disclosure relate to testing mobile device management (MDM) using a virtual mobile device that can mimic a physical mobile device, which can be used for testing and validation of MDM workflow.

MDM is a basic support solution for enterprises to implement a mobility policy and can be intended to perform unified security management on a large quantity of various mobile devices used in the enterprises. For example, the enterprises can implement device system upgrade and device configuration management of the mobile devices based on MDM.

A physical mobile device, which is managed, can be connected to a MDM server through the internet. A MDM service provider can provide device management services for enterprises through the MDM server. With these services, the enterprises can upgrade device systems of the mobile devices, and centrally manage and deploy device registration, device networking, device users, device content, and the like. In addition, the MDM service provider can provide other tasks relating to the mobile devices.

MDM enrollment involves using a physical mobile device as a check in protocol to validate device eligibility during initialization for enrolling in an enterprise service.

Embodiments of the present disclosure relate to creating a virtual mobile device, which mimics a physical mobile device, using a virtual mobile device module, and using the virtual mobile device for testing and validation of MDM workflows. Using physical mobile devices for testing and validation of MDM workflows can be costly because of overhead maintenance of the physical mobile devices. An advantage of embodiments of the present disclosure is that the virtual mobile device can help organizations to cut procurement costs of mobile devices and their operational expenses.

A robust MDM server that can handle various application programming interface (API) requests and responses goes into creating the virtual mobile device of the present disclosure. Embodiments of the present disclosure include creating an enrollment request, creation of an identity certificate for the virtual mobile device, check-in of the virtual mobile device to the MDM server, etc. An advantage of embodiments of the present disclosure is to maintain the least dependency on the MDM server as possible while providing correct inputs in API requests such that a response from the MDM server can be correct.

Embodiments of the present disclosure can communicate with MDM capability provider companies, such as Apple®/Google®/Windows® services, posing as a real, physical device while it is a virtual mobile device. Embodiments of the present disclosure can create an alternative to Apple Push Notification Service (APNS), for example, which can supply required responses to the virtual mobile device to make it look like the responses came via the APNS.

Embodiments of the present disclosure can handle enrollment of a virtual mobile device. The embodiments can include setting of API calls, which can basically mimic how a physical device can be used for MDM enrollment. A series of calls can include: an enrollment request; an end user license agreement; a generation of device identity certificate; check-in to a MDM server; and enrollment completion.

Embodiments of the present disclosure can test and validate various workflows with respect to MDM services. These embodiments can include test automation suites that use a virtual mobile device for their validation.

Embodiments of the present disclosure can handle various post request/responses between a MDM server and a virtual mobile device and validate functionality of the MDM server. Examples of such functionality can include pushing restrictions and settings, application (app) distribution and installation, etc.

The following example clauses illustrate a non-limiting listing of aspects of the present disclosure. Clause 1 is a method for testing MDM comprising a virtual device module establishing a unique device identifier. The method further comprises the virtual device module communicating the unique device identifier with a MDM server. Advantageously, the virtual mobile device module can help organizations to cut procurement costs of mobile devices and their operational expenses.

Clause 2 includes the features of clause 1. In this example, the method further comprises the MDM server sending an identity certificate to the virtual mobile device module. The method further comprises the virtual mobile device module storing the identity certificate in a mapping. Advantageously, the virtual mobile device module can help organizations to cut procurement costs of mobile devices and their operational expenses.

Clause 3 includes the features of clause 2. In this example, the mapping includes the unique device identifier. Advantageously, the virtual mobile device module can help organizations to cut procurement costs of mobile devices and their operational expenses. Advantageously, the virtual mobile device module can help organizations to cut procurement costs of mobile devices and their operational expenses.

Clause 4 includes the features of clause 1. In this example, the method further comprises using the unique device identifier for signing data. Advantageously, the virtual mobile device module can help organizations to cut procurement costs of mobile devices and their operational expenses.

Clause 5 includes the features of clause 4. In this example, the method further comprises establishing a transaction. Advantageously, the virtual mobile device module can help organizations to cut procurement costs of mobile devices and their operational expenses.

Clause 6 includes the features of clause 1. In this example, the method further comprises creating at least one virtual mobile device using the virtual mobile device module. Advantageously, the virtual mobile device module can help organizations to cut procurement costs of mobile devices and their operational expenses.

Clause 7 includes the features of clause 6. In this example, the method further comprises performing testing using the at least one virtual mobile device. Advantageously, the virtual mobile device module can help organizations to cut procurement costs of mobile devices and their operational expenses.

Clause 8 includes the features of clause 6. In this example, the method further comprises the virtual mobile device module sending a notification to the MDM server. The method further comprises the MDM server sending an enrollment request to the virtual mobile device. Advantageously, the virtual mobile device module can help organizations to cut procurement costs of mobile devices and their operational expenses.

Clause 9 includes the features of clause 2. In this example, the method further comprises the identity certificate signing one or more requests sent to the MDM server. Advantageously, the virtual mobile device module can help organizations to cut procurement costs of mobile devices and their operational expenses. Another advantage of aspects of the present disclosure is to maintain the least dependency on the MDM server as possible while providing correct inputs in requests such that a response from the MDM server can be correct.

Clause 10 includes the features of clause 8. In this example, the method further comprises completing enrollment of the virtual mobile device. Advantageously, the virtual mobile device module can help organizations to cut procurement costs of mobile devices and their operational expenses.

Clause 11 is a method for validating mobile device management (MDM) comprising a virtual device module sending at least one request to a MDM server. The method further comprises the virtual mobile device module storing at least one response from the MDM server to the at least one request. The method further comprises the virtual mobile device module validating the at least one response as per at least one established operating system (OS) response. Advantageously, the virtual mobile device module can help organizations to cut procurement costs of mobile devices and their operational expenses. Another advantage of aspects of the present disclosure is to maintain the least dependency on the MDM server as possible while providing correct inputs in requests such that a response from the MDM server can be correct.

Clause 12 includes the features of clause 11. In this example, the method further comprises the virtual mobile device module responding to a request from the MDM server in accordance with a request type. The method further comprises validating that the MDM server is working. Advantageously, the virtual mobile device module can help organizations to cut procurement costs of mobile devices and their operational expenses. Another advantage of aspects of the present disclosure is to maintain the least dependency on the MDM server as possible while providing correct inputs in requests such that a response from the MDM server can be correct.

Clause 13 includes the features of clause 11. In this example, the method further comprises the MDM server sending an OS upgrade request to the virtual mobile device module. The method further comprises the virtual mobile device module responding to the OS upgrade request and validating that the virtual device module includes an upgraded OS version. Advantageously, the virtual mobile device module can help organizations to cut procurement costs of mobile devices and their operational expenses. Another advantage of aspects of the present disclosure is to maintain the least dependency on the MDM server as possible while providing correct inputs in requests such that a response from the MDM server can be correct.

Clause 14 includes the features of clause 11. In this example, the method further comprises the MDM server sending an application (app) installation request to the virtual mobile device module. The method further comprises the virtual mobile device module responding to the app installation request and validating an app being installed. Advantageously, the virtual mobile device module can help organizations to cut procurement costs of mobile devices and their operational expenses. Another advantage of aspects of the present disclosure is to maintain the least dependency on the MDM server as possible while providing correct inputs in requests such that a response from the MDM server can be correct.

Clause 15 is a method of enrolling a virtual mobile device using mobile device management (MDM) comprising a virtual device module generating a virtual mobile device. The method further comprises the virtual mobile device module sending a request to a MDM server. The method further comprises the MDM server sending an enrollment request to the virtual device. The method further comprises the virtual mobile device requesting an identity certificate to the MDM server. The method further comprises the identity certificate signing one or more requests sent to the MDM server. The method further comprises completing enrollment of the virtual mobile device. Advantageously, the virtual mobile device module can help organizations to cut procurement costs of mobile devices and their operational expenses. Another advantage of aspects of the present disclosure is to maintain the least dependency on the MDM server as possible while providing correct inputs in requests such that a response from the MDM server can be correct.

Clause 16 includes the features of clause 15. In this example, the method further comprises the virtual device creating and pushing restrictions. Advantageously, the virtual mobile device module can help organizations to cut procurement costs of mobile devices and their operational expenses. Another advantage of aspects of the present disclosure is to maintain the least dependency on the MDM server as possible while providing correct inputs in requests such that a response from the MDM server can be correct.

Clause 17 includes the features of clause 15. In this example, the method further comprises the virtual device creating and pushing settings. Advantageously, the virtual mobile device module can help organizations to cut procurement costs of mobile devices and their operational expenses. Another advantage of aspects of the present disclosure is to maintain the least dependency on the MDM server as possible while providing correct inputs in requests such that a response from the MDM server can be correct.

Clause 18 includes the features of clause 15. In this example, the method further comprises the virtual device creating and pushing an application (app). Advantageously, the virtual mobile device module can help organizations to cut procurement costs of mobile devices and their operational expenses. Another advantage of aspects of the present disclosure is to maintain the least dependency on the MDM server as possible while providing correct inputs in requests such that a response from the MDM server can be correct.

Clause 19 includes the features of clause 15. In this example, the method further comprises the virtual mobile device responding to a request from the MDM server in accordance with a request type. The method further comprises validating that the MDM server is working. Advantageously, the virtual mobile device module can help organizations to cut procurement costs of mobile devices and their operational expenses. Another advantage of aspects of the present disclosure is to maintain the least dependency on the MDM server as possible while providing correct inputs in requests such that a response from the MDM server can be correct.

Clause 20 includes the features of clause 15. In this example, the method further comprises the MDM server sending an operating system (OS) upgrade request to the virtual mobile device. The method further comprises the virtual mobile device responding to the OS upgrade request and validating that the virtual device module includes an upgraded OS version. Advantageously, the virtual mobile device module can help organizations to cut procurement costs of mobile devices and their operational expenses. Another advantage of aspects of the present disclosure is to maintain the least dependency on the MDM server as possible while providing correct inputs in requests such that a response from the MDM server can be correct.

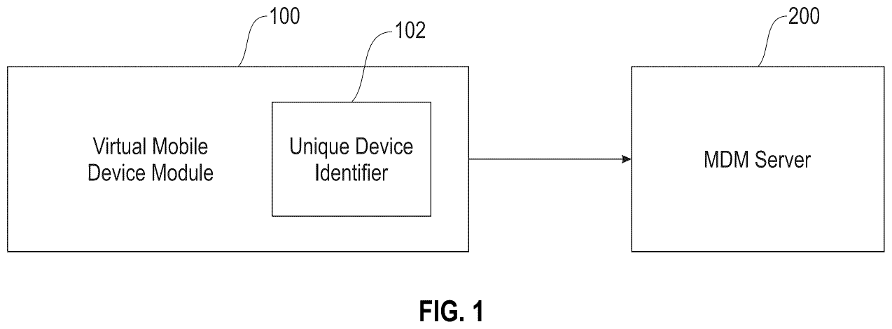

Turning to the figures, the figures illustrate possible steps or operations in a method or process involved in testing MDM using a virtual mobile device. FIG. 1 is a block diagram illustrating interaction between a virtual mobile device module 100 and a MDM server 200, in accordance with embodiments of the disclosure. The virtual mobile device module 100 can establish a unique identity with the MDM server 200 in the form of a unique device identifier 102. The unique device identifier 102 can be an alphanumeric text generated by any unique alphanumeric text generation algorithm, for example. The virtual mobile device module 100 includes code that can create a virtual mobile device that can mimic how a physical mobile device can be used in MDM enrollment. The virtual mobile device module 100 can be used to test and validate various MDM services (such as push restrictions, a setting, or distribution of an application for installation) that various MDM providers can offer.

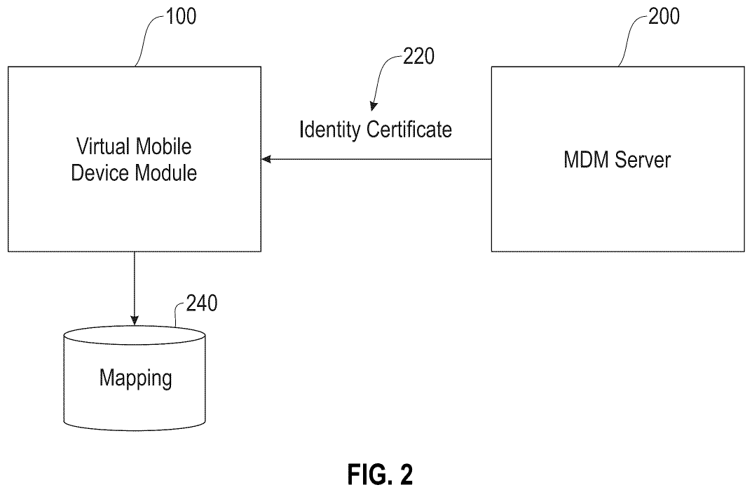

FIG. 2 is a block diagram illustrating another interaction between the virtual mobile device module 100 and the MDM server 200, in accordance with embodiments of the disclosure. The virtual mobile device module 100 can receive and store an identity certificate 220 that can be returned by the MDM server 200 in response to the establishment of a unique identity by the virtual mobile device module 100 with the MDM server 200. The identity certificate 220 can be defined as an encrypted digital certificate used to verify and authenticate a device's identity within a MDM service, which can enable secure communication between a device and the MDM server 200. The virtual mobile device module 100 can store the identity certificate 220 in a form of a mapping 240 and can use the identity certificate 220 in a subsequent request to sign data. A subsequent request, or any subsequent communication with the MDM server 200, can be for various functionalities such as sending device data, app installation, etc. Virtual mobile devices can each have a unique device identifier 102 (in FIG. 1) and any further actions on such virtual mobile device can make use of the unique device identifier 102 (in FIG. 1) for signing data and establishing a transaction. The data can be a response to any query or request by the MDM server 200, such as device data, app data, or configuration profiles. The transaction can be when the MDM server 200 requests and the device responds, which can complete the transaction. Multiple virtual mobile devices can be created using the process shown in FIG. 2 for different testing strategies, which can be functional testing or performance testing. Functional testing can be, for example, when a device accepts a request only at a certain operating system (OS) version, or when an OS upgrade request can only happen from a lower to higher OS version. If the device is already on a higher OS version, it can reject the request. A MDM server, such as MDM server 200, can be able to handle both rejection and acceptance. For performance testing, a lot of virtual devices simultaneously communicate with the MDM service to test the capability of the MDM server (such as MDM server 200) to handle parallel requests to a certain threshold and keep the response time in an acceptable limit.

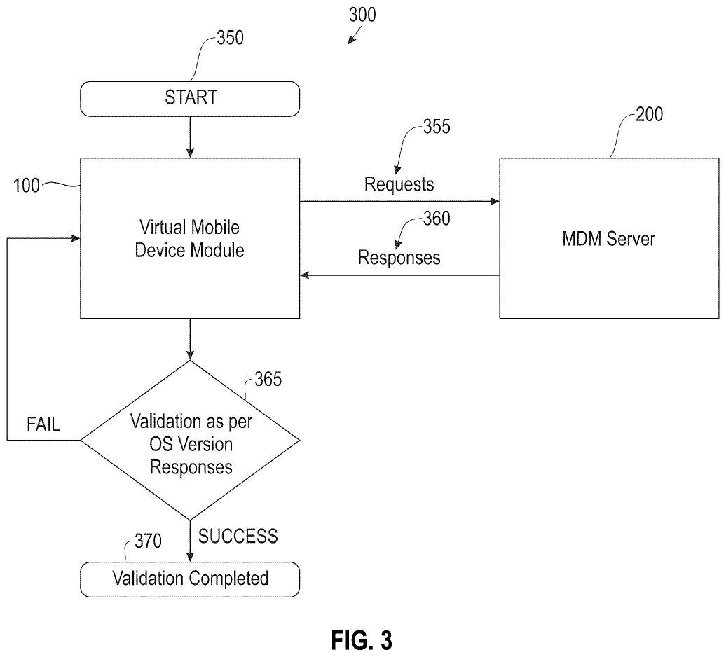

FIG. 3 is a flow diagram illustrating a validation process 300, in accordance with embodiments of the present disclosure. In order to start the validation process 350, a notification can be sent to the MDM server 200. As shown, the virtual mobile device module 100 can produce a set of requests 355, which can mimic how a physical mobile device can be used in MDM enrollment of the physical mobile device. The requests 355 can be signed by an identity certificate (such as in 220 in FIG. 2) that can make the requests 355 look like they are coming from a physical mobile device. The identity certificate (such as the identity certificate 220 in FIG. 2) can be stored in a mapping (such as the mapping 240 in FIG. 2). Also, the virtual mobile device module 100 can receive and store responses 360 from the MDM server 200 to various requests 355 and can validate the responses 360 as per established OS version responses (block 365). The virtual mobile device module 100 can also respond to any request of the MDM server 200, in accordance with the request type, such that work of the MDM server 200 can be validated. The request type can be, but is not limited to, app installation, OS upgrade, or MDM action, like a restart of a device, etc. The validation can include that the MDM is working. If an acknowledgement or data from the device is processed successfully by the MDM server 200 and a next request if any, is available, then it can be sent to the device by the MDM server 200. For example, the MDM server 200 can request the device data, the device can respond with the right or correct data, such as OS version, device model etc. MDM server requests can be processed by the MDM server 200 and a subsequent install app request can be sent to the device, after evaluating that the app in the request is applicable for the OS version which was sent by the previous response of the device. If the validation process is successful, then validation can be completed (block 370). If the validation fails, then the figure shows a return to the virtual mobile device module 100.

The virtual mobile device module 100 can, for example, be used across different windows and can validate MDM services that are offered. As an example, if an OS update is desired, the virtual mobile device module 100 can respond to an OS upgrade request of the MDM server 200 such that a right value of upgrade for an OS upgrade feature can be validated. Similarly, if the virtual mobile device module 100 desired to install an app, the virtual mobile device module 100 responds to an app installation request of the MDM server 200 with a correct app being installed. Various MDM functionalities can be validated using the process shown in FIG. 3.

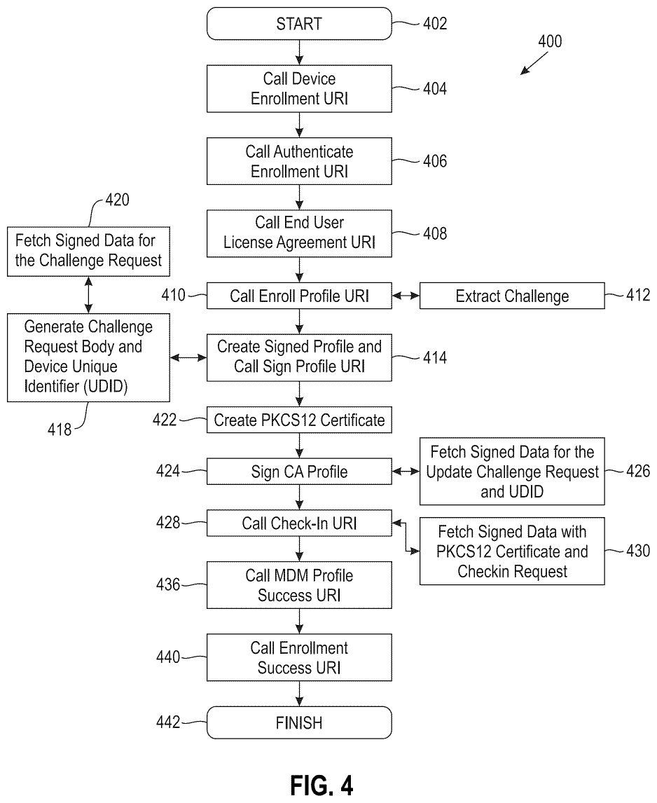

FIG. 4 is a flow diagram illustrating a validation process 400, in accordance with embodiments of the present disclosure. The validation process has a start or initiation operation 402. Another operation 404 that can follow is a call for a device enrollment uniform resource identifier (URI). Another operation 406 can be a call to authenticate the enrollment URI. The operation 406 of authentication can include generation of requests (such as the requests 355 in FIG. 3). Another operation 408 can be a call for an end user license agreement URI. A further operation 410 can be a call for an enroll profile URI. The operation 410 of the call for the enroll profile URI can extract a challenge (operation 412). The challenge can refer to a security measure used to verify the identity of the user enrolling the device. The challenge can ensure that only authorized users can enroll devices into the MDM service. Yet another operation 414 can be to create a signed profile and call a sign profile URI. The operation 414 can alternatively, or additionally, result in another operation 418 of generation of a challenge request body and unique device identifier (UDID). The operation 418 can also result in an operation 420 of fetching signed data for the challenge request. Fetching can include extracting profile data in an unencrypted format. After the operation 414, an operation 422 of creation of a PKCS12 certificate can occur. Yet another operation 424 can be to sign a MDM profile. The operation 424 can result in an operation 426 of fetching signed data for the update challenge request and UDID. A further operation 428 can be calling a check-in URI. As a result of the operation 428, another operation 430 can be fetching signed data with the PKCS12 certificate and a check-in request, which can be a URI hosted by the MDM server to let the devices confirm their enrollment and identity. An additional operation 436 can be to call a MDM profile success URI, which can be used by the virtual mobile device module to get the profile success URI. A further operation 440 can be calling an enrollment success URI, which can be used by the virtual mobile device module to update the enrollment success status. The process 400 can end with a finish operation 442.

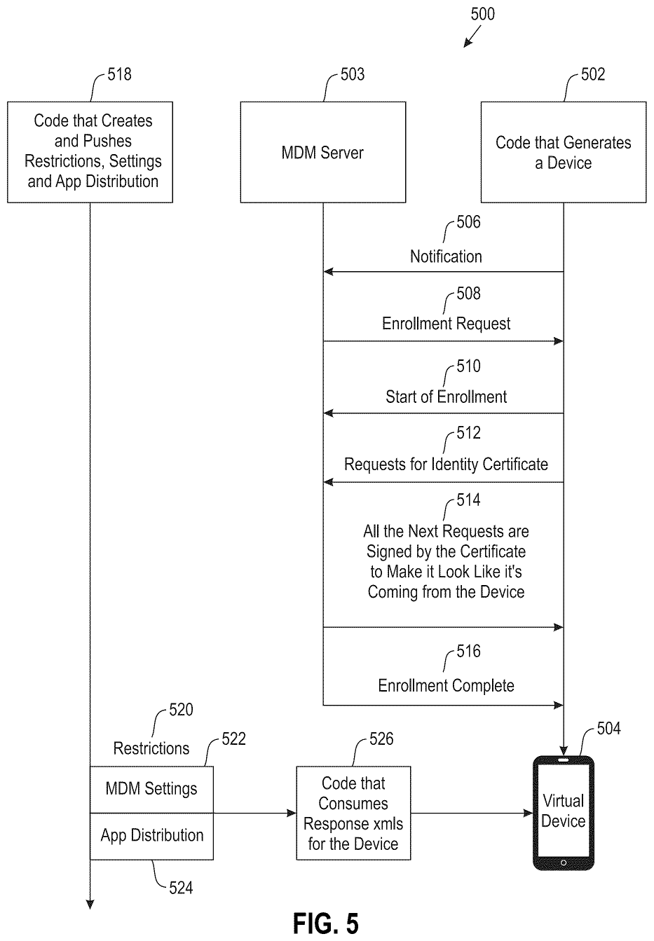

FIG. 5 is a block diagram illustrating a virtual device MDM enrollment process 500, in accordance with embodiments of the present disclosure. The process 500 includes a block 502 of code that can generate a virtual device 504. A notification 506 can be sent from the block 502 (a virtual device module) to a MDM server 503. An enrollment request 508 can be sent from the MDM server 503 to the code in block 502. A start of enrollment, as indicated by 510, can occur next. A request for an identity certificate 512 can be sent from the code in block 502 to the MDM server 503. As indicated by 514, next requests are signed by the identity certificate to make to look like the requests are coming from the virtual device 504. Enrollment can then be complete as indicated by 516. As shown, code that can create and push restrictions 520, MDM settings 522 and app distribution 524 can be included and is indicated by block 518. Block 526 indicates that code that consumes response extensible markup languages (xmls) for the virtual device 504.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

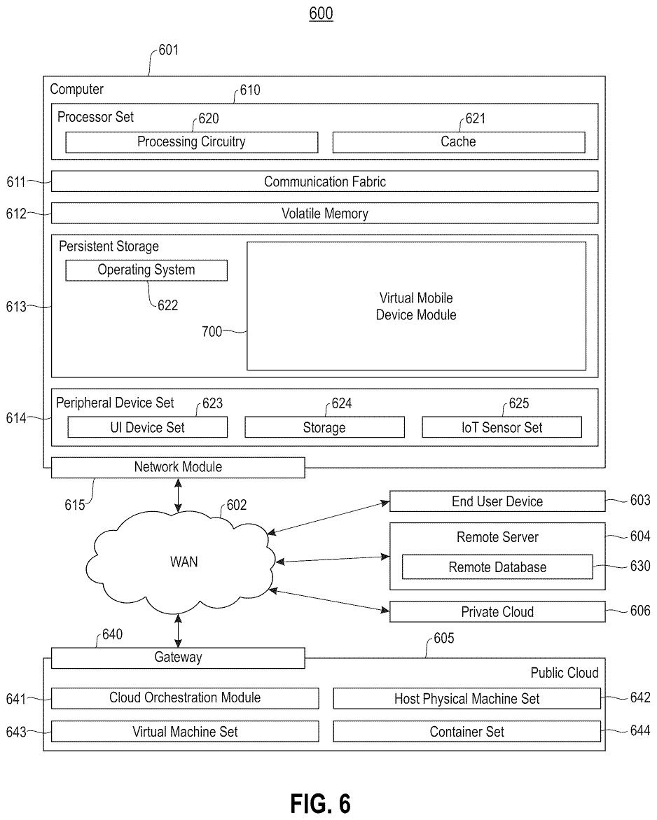

As in FIG. 6, computing environment 600 contains an example of an environment for the execution of at least some of the computer code involved in performing the disclosed methods, such as virtual mobile device module block 700. In addition to block 700, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 700, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 621 and the other storage media discussed below. The program instructions, and associated data, are accessed by processor set 610 to control and direct performance of the disclosed methods. In computing environment 600, at least some of the instructions for performing the disclosed methods may be stored in block 700 in persistent storage 613.

Communication fabric 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface-type operating systems that employ a kernel. The code included in block 700 typically includes at least some of the computer code involved in performing the disclosed methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer, and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the disclosed methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601) and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

As used in this application and in the claims, the singular forms “a,” “an,” and “the” include the plural forms unless the context clearly dictates otherwise. Additionally, the term “includes” means “comprises.”

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for testing mobile device management (MDM), the method comprising:
a virtual device module establishing a unique device identifier; and
the virtual device module communicating the unique device identifier with a MDM server.

2. The method of claim 1, further comprising:
the MDM server sending an identity certificate to the virtual mobile device module; and
the virtual mobile device module storing the identity certificate in a mapping.

3. The method of claim 2, wherein the mapping includes the unique device identifier.

4. The method of claim 1, further comprising:
using the unique device identifier for signing data.

5. The method of claim 4, further comprising:
establishing a transaction.

6. The method of claim 1, further comprising:
creating at least one virtual mobile device using the virtual mobile device module.

7. The method of claim 6, further comprising:
performing testing using the at least one virtual mobile device.

8. The method of claim 6, further comprising:
the virtual mobile device module sending a notification to the MDM server; and
the MDM server sending an enrollment request to the virtual mobile device.

9. The method of claim 2, further comprising:
the identity certificate signing one or more requests sent to the MDM server.

10. The method of claim 8, further comprising:
completing enrollment of the virtual mobile device.

11. A method for validating mobile device management (MDM), the method comprising:
a virtual device module sending at least one request to a MDM server;
the virtual mobile device module storing at least one response from the MDM server to the at least one request; and
the virtual mobile device module validating the at least one response as per at least one established operating system (OS) response.

12. The method of claim 11, further comprising:
the virtual mobile device module responding to a request from the MDM server in accordance with a request type; and
validating that the MDM server is working.

13. The method of claim 11, further comprising:
the MDM server sending an OS upgrade request to the virtual mobile device module; and
the virtual mobile device module responding to the OS upgrade request and validating that the virtual device module includes an upgraded OS version.

14. The method of claim 11, further comprising:
the MDM server sending an application (app) installation request to the virtual mobile device module; and
the virtual mobile device module responding to the app installation request and validating an app being installed.

15. A method of enrolling a virtual mobile device using mobile device management (MDM), the method comprising:
a virtual device module generating a virtual mobile device;
the virtual mobile device module sending a request to a MDM server;
the MDM server sending an enrollment request to the virtual device;
the virtual mobile device requesting an identity certificate to the MDM server;
the identity certificate signing one or more requests sent to the MDM server; and
completing enrollment of the virtual mobile device.

16. The method of claim 15, further comprising:
the virtual device creating and pushing restrictions.

17. The method of claim 15, further comprising:
the virtual device creating and pushing settings.

18. The method of claim 15, further comprising:
the virtual device creating and pushing an application (app).

19. The method of claim 15, further comprising:
the virtual mobile device responding to a request from the MDM server in accordance with a request type; and
validating that the MDM server is working.

20. The method of claim 15, further comprising:
the MDM server sending an operating system (OS) upgrade request to the virtual mobile device; and
the virtual mobile device responding to the OS upgrade request and validating that the virtual device module includes an upgraded OS version.
